(19) United States
(12) Patent Application Publication
(10) Pub. No.: US 2015/0319375 A1
(43) Pub. Date: Nov. 5, 2015

(54) APPARATUS AND METHOD FOR CREATING REAL-TIME MOTION (STROBOSCOPIC) VIDEO FROM A STREAMING VIDEO

(71) Applicant: SONY CORPORATION, Tokyo (JP)

(72) Inventor: Sabri Gurbuz, Sunnyvale, CA (US)

(73) Assignee: SONY CORPORATION, Tokyo (JP)

(21) Appl. No.: 14/265,694

(22) Filed: Apr. 30, 2014

(51) Int. Cl. H04N 5/262; H04N 5/77

(52) U.S. Cl. CPC H04N 5/2625; H04N 5/772

(57) ABSTRACT

Real-time generation of motion (stroboscopic) video is described which utilizes an object tracking process operating on downsized images in a circular buffer. Utilizing object information from the tracking, a background static scene is extracted into which multiple temporally displaced object images are inserted to create a stroboscopic video frame. Due to its low processing overhead, the apparatus and method is particularly well-suited for implementation on portable devices, such as cameras and cellular phones.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Field of the Technology

This disclosure pertains generally to video processing, and more particularly to generating real-time stroboscopic video.

2. Background Discussion

Motion video, also referred to as stroboscopic video, is an output in which one or more moving objects are seen spatially displaced in a single frame of moving objects which are temporally displaced in the frames of the input video. A stroboscopic image is a single image, of this nature, while a stroboscopic video depicts the actual moving object position as well as a trail of separated previous positions of that object.

The use of a motion video (stroboscopic) generation can be important in numerous image and video applications (e.g., sports video post-production). However, the steps involved in generating stroboscopic video is a complex process whose results are often less than satisfactory. Due to its significant overhead, typical methods of performing stroboscopic video generation are not well-suited for real-time execution, such as on cameras and mobile devices.

Accordingly, a need exists for a practical stroboscopic video generation apparatus and method which is sufficiently simple for real time implementation in various applications, including on cameras and mobile devices.

### BRIEF SUMMARY OF THE TECHNOLOGY

A method and apparatus is described for creating real-time motion (stroboscopic) video either from a streaming video (video input) or from a camera memory. The apparatus utilizes a circular set of downsized tracking buffers, and a set of full size buffers. The smaller tracking buffers are utilized for performing object tracking routines which provide information about the moving objects, including object mask and bounding box. Information about the tracked objects is then converted to full size and utilized with the application buffers to extract a background scene, upon which temporally displaced object images are inserted to create a stroboscopic frame. The process is continued with additional frames in generating a stroboscopic video output.

Further aspects of the technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The disclosure will be more fully understood by reference to the following drawings which are for illustrative purposes only:

FIG. 1 is a block diagram of a real-time stroboscopic video generation apparatus utilizing circular source and tracking buffers according to an embodiment of the present disclosure.

FIG. 2 is a flow diagram of real-time stroboscopic video generation according to an embodiment of the present disclosure.

FIG. 3 is a flow diagram of a scale undo operation for object masks utilized according to an embodiment of the present disclosure.

FIG. 4 is a flow diagram of the formation of motion (stroboscopic) video frame(s) according to an embodiment of the present disclosure.

FIG. 5A and FIG. 5B is a flow diagram of object mask detection utilized according to an embodiment of the present disclosure.

FIG. 6 is a flow diagram of the object contour detection process utilizing the difference image according to an embodiment of the present disclosure.

### DETAILED DESCRIPTION

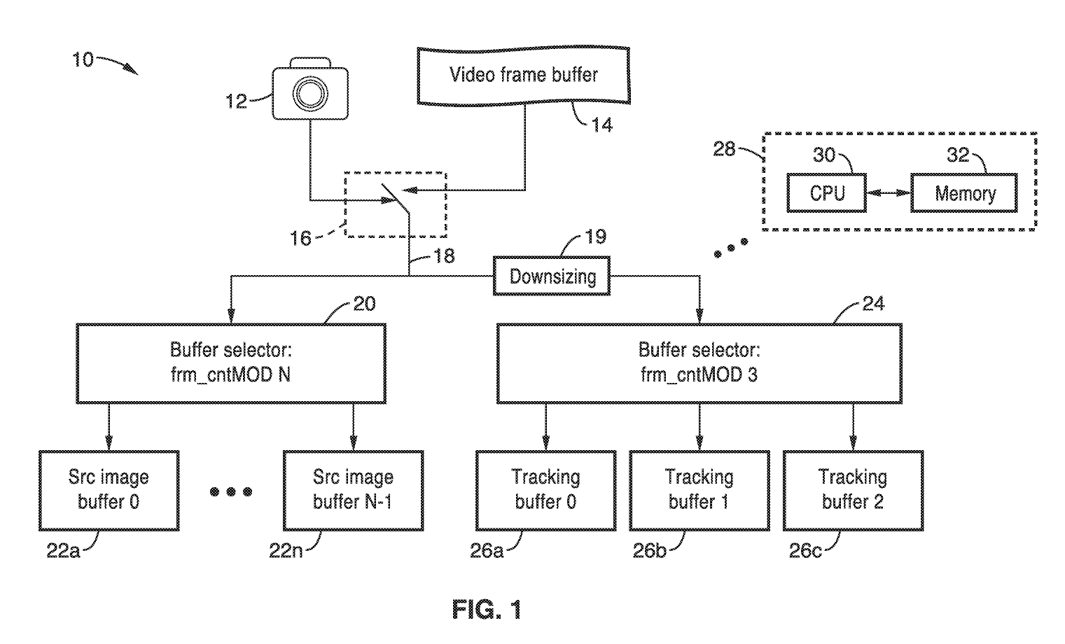

FIG. 1 illustrates an example embodiment 10 for generating real-time motion video, also referred to as stroboscopic video, from a streaming video, or image sequence. It should be appreciated that a single stroboscopic image can be output as a still image, such as one frame from said stroboscopic video. As seen from the block diagram, the image sequence being processed may be received from either a camera 12, or from a video frame buffer 14, such as contained within a video processing system or other device for retaining video frames. Switch 16 in the figure merely represents that there are multiple options for video frame sequence 18 to be received for inventive processing.

Incoming image frames in frame sequence 18 are downsized 19 for use in tracking for computational cost reasons; by way of example a 1920×1080 HD input image can be downsized to 480×270 by sub-sampling. The downsized frame sequence is stored in a multiple frame circular buffer, such as preferably including three frames 26a, 26b, 26c, as selected by a buffer selector 24. The current and previous original sized source images (not downsized) are stored in a separate buffer, such as having two frames, for the motion video application. The figure depicts N buffers (0 through N−1) 22a-22n selected by selector 20.

Consider the case where there are three pointers pointing to buffer0, buffer1 and buffer2, and it is desired to extract moving objects at frame #67 in video. Then frame #65 (I1), frame #66 (I2), and frame #67 (I3) are needed in the buffers. Then the pointers are given by (67-2) MOD 3=1, (67-1) MOD 3=0, (67-0) MOD 3=2, so that prv_ptr for I1 will point to buffer1, cur_ptr for I2 will point to buffer0, and next_ptr for I3 will point to buffer2. When the frame number advances to 68, the inventive apparatus only changes pointer addresses where they point to depending on MOD arithmetic: prv_ptr=Buffer[66 MOD 3], cur_ptr=buffer[67 MOD 3], next_ptr=buffer[68 MOD 3]. Accordingly, the apparatus does not require copying images from one buffer to another. In the above case, the current image actually is the previous image (one frame delay) so the system stores two frames at least for the original image 22a and 22n.

It will be appreciated that embodiments of the present technology can include more than three buffers to increase the robustness of the system. The current object detection core of this embodiment is based on |I1-I2|̂|I2-I3| where I2 is the center image and, |.| is the absolute operation, and ̂ is the intersection operation. If we increase the buffer size to say five, then I3 will be the center image. Then one can utilize |I1-I3|̂|I3-I5| that results in moving object locations in image I3; or alternately |I1-I3|̂|I3-|I5|+|I2-I3|̂|I3-I4| can be utilized.

Downsizing is preferably performed by first re-sizing the image, such as to a VGA size, prior to storing in circular buffer 26a-26c. The circular buffer is configured for storing three frames with buffer transitions 0→1→2→0→1 and so on. It will be appreciated that the modulo operator in the C language is represented by “%”. Image frame n=0 will be placed to buffer[0% 3=0], frame n=1 will be placed to buffer[1% 3=1], frame n=2 will be placed in buffer[2% 3=2], frame n=3 will be placed in buffer[3% 3=0], and frame n=4 will be placed in buffer[4% 3=1] and so on. Inside of the [.] are only 0, 1, and 2. That is, if we need to access the previous frame# n−1 later, then prv_ptr=buffer[(n−1)% 3]. Likewise, original source image is also stored in a circular buffer capable of storing at least two frames. The previous image information is necessary for the motion video application development. In this operation |I1-I2|̂|I2-I3| image I2 is considered as the current image; indeed, it is actually the previous image. However, the apparatus uses I3 as the current image in the next frame processing. Therefore, the inventive apparatus stores the last two original frames.

Tracking image buffers 26a-26c, are of a size that is less than or equal to the source image size. Tracking buffers are utilized for object extraction. The source image buffers 22a through 22n, include N buffers (0 to N−1) which are utilized for post-image formation (application), such as placing multiple poses (positions) of objects in a single frame (stroboscopic image formation) where objects are extracted from image sequences of video. In at least one embodiment of the present technology, N is defined as BUF_LENGTH in the code, which by way of example can be defined as BUF_LENGTH=2.

Control of buffer selection as well as the object detection and extraction process are preferably performed by at least one processing element 28, such as including at least one computer processor 30 (e.g., CPU, microprocessor, microcontroller, DSP, ASIC with processor, and so forth), operating in conjunction with at least one memory 32. It will be appreciated that programming is stored on memory 32, which can include various forms of solid state memory and computer-readable media, for execution by computer processor 30. The present technology is non-limiting with regard to types of memory and/or computer-readable media, insofar as these are non-transitory, and thus not constituting a transitory electronic signal.

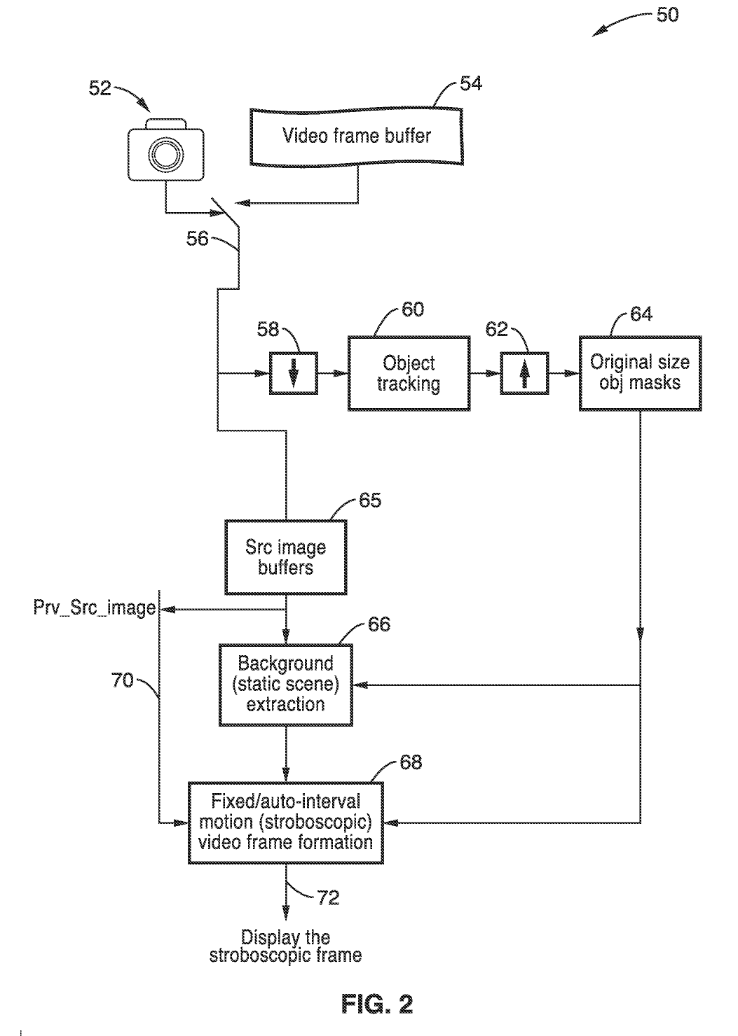

FIG. 2 illustrates an example embodiment 50 of motion (stroboscopic) video generation in the system. Video is received from a camera 52, or video frame buffer/streaming video source 54 as a source video 56 received into source buffers 65, which were described in FIG. 1. Incorporated within the stroboscopic video generation process is a tracking process based on moving object detection and extraction, seen in blocks 58 through 64. The information generated from object tracking is utilized as a basis from which moving objects are generated in a stroboscopic sequence with multiple, temporally displaced, copies of the object in a given frame.

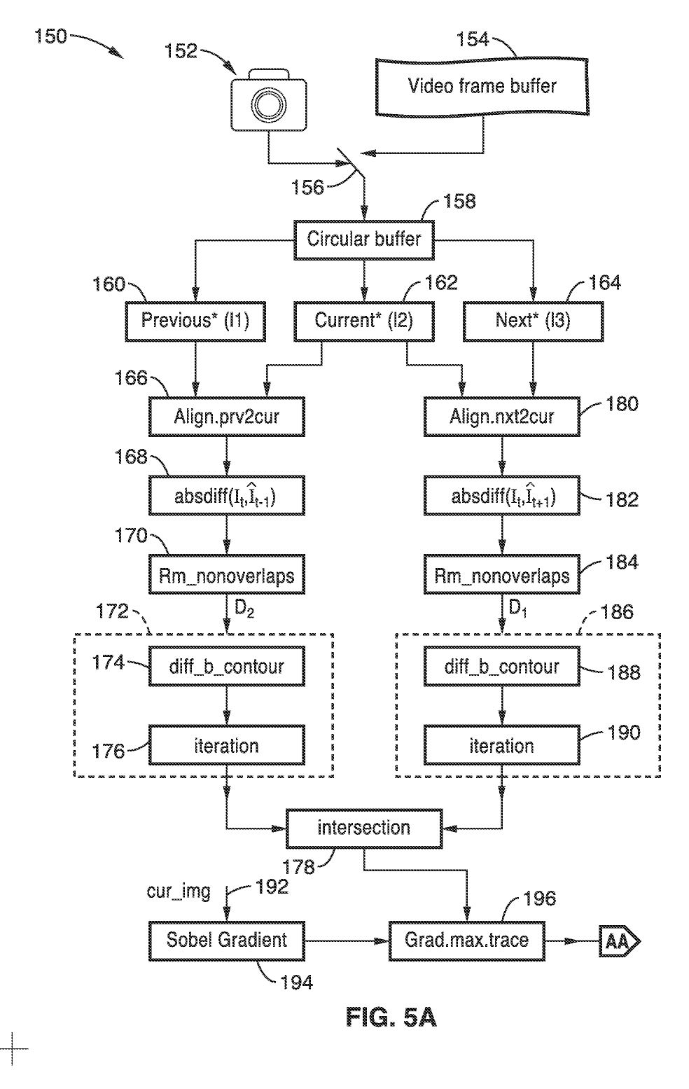

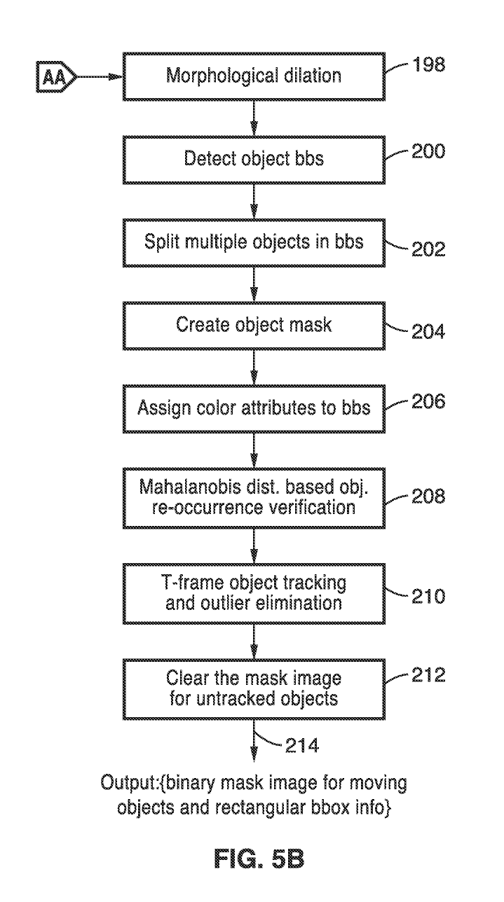

The stroboscopic video system extracts the moving objects from the current, previous and next image frames in the streaming video with one frame delay in real time (on the fly). In particular, after downsizing 58 and storing the tracking sized images into tracking buffers (such as tracking buffers 26a, 26b and 26c, in FIG. 1), a process of moving object extraction 60 is performed for which a detailed flow diagram is provided in FIG. 5A through FIG. 5B described later. In general, the extraction process involves aligning these images using an image alignment process (e.g., global whole frame image alignment method (process) from Sony). Then, the absolute difference between these tracking buffers are calculated (for each new frame) to create two difference images. A relative threshold operation is executed for detecting the rough object contours in these two difference images. The resulting contour images are intersected to obtain the object contours corresponding to the center buffer (buffer1) image. Then, the bounding box of each object in the buffer1 is located to detect a generous object mask for each object. Once the objects are detected/tracked 60 then the object information is upsized 62 into full size object masks 64 for use with source image buffers.

The object masks generated from object tracking is then utilized in the stroboscopic generation process on the full size image stored in source image buffers 65 (buffers 22a through 22n of FIG. 1). A background scene extraction process is performed 66, followed by fixed or auto-interval motion (stroboscopic) video frame formation 68 which also utilizes object mask information and receives the previous source image frame 70 from source image buffers, before outputting a stroboscopic image frame 72.

Stroboscopic generation is repeated for every incoming image frame. In particular, the objects are inserted into the current frame only if they fall into the current image frame after motion compensation. The object insertion interval can be decided either by the user or by the system automatically. It will be appreciated that the system can select a predetermined object insertion interval, or select one based upon motion characteristics determined from object motion in the video input. The resulting video is called motion video or alternately stroboscopic video.

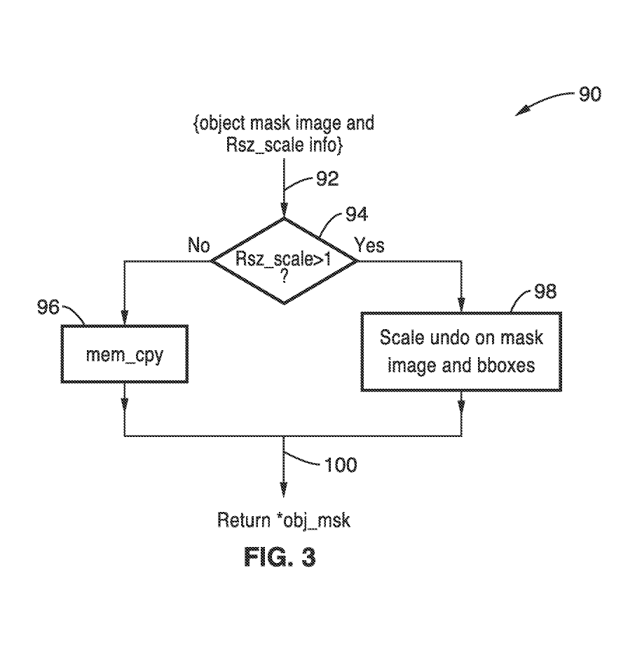

FIG. 3 illustrates an example embodiment 90 of a scale undo operation for received object masks 92. If the tracking buffers have been downsized, as detected in block 94, then a scale undo 98 is performed on the mask image and associated bounding boxes. In particular, if the re-size (downsize) scale in 94 that was originally set in 58 of FIG. 2 is greater than one, then the object mask image and its bounding box information are up-scaled to the original size in 98. If the re-size (downsize) scale in 94 is equal to one, then the object mask image and its bounding box information is copied to the application buffer directly with a memcpy command. In either case, a properly sized object mask 100 is returned. Otherwise a memory copy is performed 96. The function outputs 100 an object mask that can be utilized on the full scale source images.

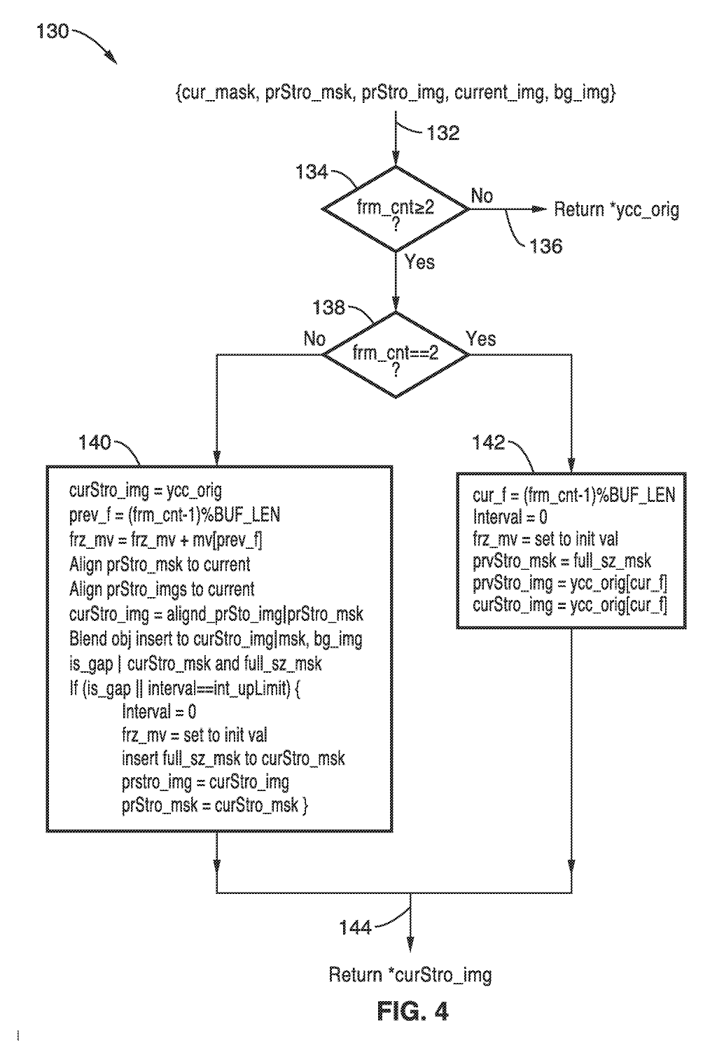

FIG. 4 illustrates an example embodiment 130 of forming motion (stroboscopic) video frames. The stroboscopic interval for placing objects in the motion video frames can be determined by the inventive method automatically given a user specified (e.g., default) interval upper limit. Stroboscopic generation commences after at least two frames have been collected. Execution 132 reaches block 134, and if the frame count is not at least two, then a return 136 is made with the input image being returned as is a motion video frame. Block 138 is reached when at least two frames has been received. If the frame count is on the second frame then block 142 is executed to set the current frame pointer and other initializations, described below.

It will be appreciated that completing initialization for stroboscopic generation involves receipt of two frames, while commencing the generation of stroboscopic output involves receipt of three frames. It will be appreciated, therefore, that at least two frames are used for initialization, and at least three frames for commencing to generate stroboscopic output.

Initialization on the second frame preferably includes: (a) assigning the current frame pointer to the current image; (b) setting the interval counter to zero; (c) initializing the stroboscopic motion vector (frz_mv) to zero; (d) copying the current object mask to the previous stroboscopic object mask; (e) copying the current image to the previous stroboscopic image; (f) copying the current image to the current stroboscopic image; and finally (g) a return of the stroboscopic image.

When the frame count (frm_cnt) is greater than two, then block 140 is executed, the process preferably including: (a) assigning the current image frame to the current stroboscopic image; (b) setting the previous frame pointer; (c) adding the motion vector from the previous frame to the motion vector of the stroboscopic frame; (d) aligning the previous stroboscopic mask with the current image; (e) aligning the previous stroboscopic image with the current image; (f) copying the aligned previous stroboscopic object areas by utilizing the aligned previous object mask; (g) copying the objects in the current frame to the current stroboscopic image by utilizing the current object mask and the background image; (h) checking for the stroboscopic object gap by intersecting the current stroboscopic mask and the current object mask; (i) if a gap exists between the current stroboscopic mask and the current object mask, or the interval counter is equal to an interval upper limit, then the following is executed: (i) setting the interval counter to zero; (ii) setting the stroboscopic motion vector (frz_mv) to zero; (iii) copying the current object mask to the current stroboscopic object mask; (iv) copying the current stroboscopic image to the previous stroboscopic image; (v) copying the current stroboscopic object mask to the previous stroboscopic object mask. After which the stroboscopic image is returned 144.

FIG. 5A and FIG. 5B illustrate an embodiment 150 of the tracking process based on object detection and extraction, which is utilized in the process of generating stroboscopic video from the sequence of images. It will be appreciated that a computer processor and memory, such as seen in FIG. 1, are preferably utilized for carrying out the steps of the inventive method, although not depicted for simplicity of illustration.

It is also seen in this figure, that the image sequence being processed may be selected 156 either from a camera 152 or from a video frame buffer 154, in which a video frame sequence is put into a circular buffer 158.

In order to detect and extract multiple moving objects, downsized images are stored in a circular buffer as was shown in FIG. 1. The tracking buffer is seen for retaining at least three consecutive images: previous 160, current 162, and next 164, as I1, I2, and I3. Separate processing paths, 166-176 and 180-190, are seen in the figure for processing inputs from both I1 and I2, or I2 and I3, respectively.

Alignment is performed 166, 180, on previous and next, respectively, with respect to static scenes in the image at every incoming frame instance utilizing a known image alignment process, preferably utilizing the global whole frame image alignment algorithm from Sony. The absolute difference is determined between the aligned I1 and I2 in 168, and likewise the aligned I3 and I2 in 182. After removing the non-corresponding (non-overlapping areas at frame borders after the alignment) redundant regions at frame borders in the difference images 170, 184, then contours 172, 186 of the objects are detected on each difference image. This can be understood by considering a video camera which is capturing video. The camera moves towards the right whereby a partially new scene is being captured that was not in the previous frame. Then, when the previous and current frames are aligned, there wouldn't be a correspondence scene at the right frame border due to non-overlapping camera field of view, and this is what is considered a “non-corresponding” area after the alignment.

It will be seen that this process of determining the contours is iterative, shown exemplified with diff b contours 174, 188, and iteration control iteration 176, 190. An initial object contour is determined from a first pass, with contour detection utilizing a lower sensitivity threshold for further search of object contours using the initial object contour results from the previous modules, within additional iterations, typically pre-set to two iterations. The contour detection process results in creating double object contours, as in both difference images, due to the movement in time of the object. Therefore, an intersection operation is performed 178 to retain the contours of objects in current image I2 only in locations where object contours are located.

In some cases, part of the object contour information may be missing. Accordingly, to recover missing contour information, a gradient of image I2 (from cur_img) 192 is determined 194, such as using a Sobel gradient, and the contour is recovered utilizing gradient tracing 196, such as utilizing a function Grad.max.trace. Preferably this step includes a maximum connecting gradient trace operation to recover any missing object contours.

The recovered contour is output to a block which performs additional processing seen in FIG. 5B. Morphological dilation 198 is performed so that object contour data is dilated to close further gaps inside the contour. An object bounding box is determined 200, such as using a function bbs for performing bounding box (bb) for each object. Initial bounding box information of the objects is detected, preferably by utilizing vertical and horizontal projection of the dilated contour image. However, in some cases, a larger object may contain a smaller object. Therefore, a splitting process 202 is performed that is based on region growing, and which is utilized to split the multiple objects, if any, in each bounding box area to separate any non-contacting objects in each bounding box.

A mask image bounded by each object contour is created 204. In order to track objects temporally (i.e., with respect to time), color attributes of objects are extracted from the input image corresponding to object mask area and color assignments stored in the object data structure 206. Then, the objects in the current frame are verified, such as preferably utilizing Mahalanobis distance metric 208 using object color attributes, with the objects in the previous T frames (where T=1 is the default value). Then, the objects that are not verified (not tracked) in the verification stage of the T consecutive frames are considered as outliers and removed from the current object mask image 210. In at least one embodiment of the technology, the value of T is 1, although values greater than 1 can be utilized. The attributes of the removed object are preferably still retained for verification of the objects in the next frame, in the object attribute data structure.

The mask is then cleared of the untracked objects (not verified) 212 to output a binary mask 214 of moving objects and rectangular boundary box information, as a Boolean image where detected object pixel locations are set to “true”, and the remainder set to “false”. The information about these moving objects is then utilized for background static scene extraction 66 and motion formation 68 seen in FIG. 2 to generate stroboscopic frames.

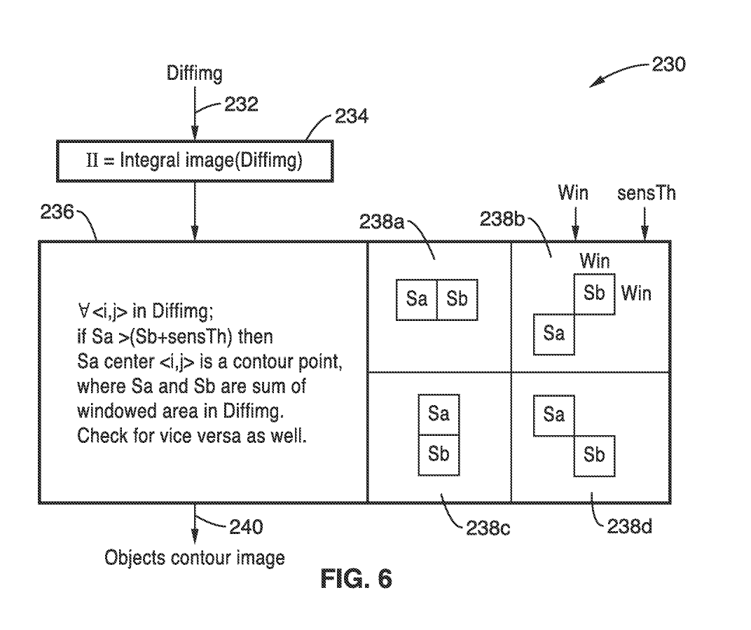

FIG. 6 illustrates the object contour detection process 230, seen in blocks 174, 188 of FIG. 5A through FIG. 5B using a difference image. Parameter diffimg 232 is received at block 234 for I1=Integral image (Diffimg). The diff_b_contour (diffimg, Win, sensTh..) method accepts three parameters: diffimg which is D₂ from 170 in FIG. 5A, the Win sub-window value (typically 7×7) and sensTh as sensitivity threshold value. Block 236 in the figure executes three separate filters to detect moving object borders on the difference image: 238a is a horizontal filter, 238b is a 45 degree filter, 238c is a 90 degree filter, and 238d is a 135 degree filter. Sa and Sb represent sum of the intensity values inside each sub-window, respectively. If Sa>(Sb+sensTh), then Sa sub-window area is considered to be on a moving object contour and set to be true in that case, where sensTh is typically assigned to value of 16 per pixel (sensTh=Win×16) at the first iteration and 8 per pixel at the second iteration.

Furthermore, the inventive method checks for the condition Sb>(Sa+sensTh). If that condition is true then the Sb sub-window area is set to be the moving object border. As a result the objects contour image 240 is output as moving object borders.

Referring to FIG. 6 it will be appreciated that this represents a dynamic thresholding process. In considering Sb>(Sa+sensTh) (sensitivity_threshold), it will be recognized that there is no hard-coded threshold, instead the threshold is preferably a relative threshold operation. In the present embodiment, the dynamic threshold is achieved by comparing a first sum of intensity value (e.g., Sa or Sb) against a second sum of intensity values (e.g., Sb or Sa) added to a sensitivity threshold sensTh as an offset. For example consider Sb=240, Sa=210, SensTh=16 that is 240>210+16, then the Equation would be true. Similarly, considering Sb=30, Sa=10, SensTh=16, that is 30>10+16, then again the equation would be true. On the other hand, consider the case with Sb=240, Sa=230, and SensTh=16, that is 240>230+16, then the equation would be false.

Embodiments of the present technology may be described with reference to flowchart illustrations of methods and systems according to embodiments of the technology, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

From the discussion above it will be appreciated that this technology can be embodied in various ways, including but not limited to the following:

1. An apparatus for generating stroboscopic output from a video input, comprising: a computer processor configured for receiving and processing a video input; a circular set of tracking buffers configured for object tracking; a set of full size frame buffers configured for use during full size frame stroboscopic generation; and programming in a non-transitory computer readable medium and executable on the computer processor for performing steps comprising: downsizing frames of said video input and storing in said circular set of tracking buffers; storing full size frames in a set of full size frame buffers; performing object tracking routines to determine object mask and bounding box information about objects moving in frames of the video input; upsizing object mask and bounding box information back to full image size for use with said set of full size frame buffers; performing background extraction in response to upsized object mask and bounding box information in relation to said full size frame buffers, so that a background is generated without moving objects; and generating spatially displaced object positions in a frame, or frames, of stroboscopic output, based on said upsized object mask and bounding box information.

2. The apparatus of any of the previous embodiments, wherein said circular set of tracking buffers comprises at least three tracking buffers for storing a downsized version of at least a previous, current and next frame.

3. The apparatus of any of the previous embodiments, wherein said programming executable on said non-transitory computer readable medium is configured to repeat stroboscopic output generation for every incoming image frame until a desired frame or frames of stroboscopic output is created.

4. The apparatus of any of the previous embodiments, wherein said programming executable on said non-transitory computer readable medium is configured to perform object tracking routines with a one-frame delay.

5. The apparatus of any of the previous embodiments, wherein said programming executable on said non-transitory computer readable medium is configured to perform said object tracking routines based on a image alignment process, followed by generating two absolute difference images for each new frame which are compared in a relative threshold operation to generate rough contours in each of absolute difference images which are intersected followed by determining a bounding box.

6. The apparatus of any of the previous embodiments, wherein said programming executable on said non-transitory computer readable medium is configured for generating a stroboscopic video frame, or frames, wherein said spatially displaced object positions are generated in the frame according to an object insertion interval performed in response to a fixed or automatic-interval motion process.

7. The apparatus of any of the previous embodiments, wherein said programming executable on said non-transitory computer readable medium is configured for selecting said object insertion interval in response to user input, or in response to a predetermined value, or in response to selecting it automatically based on motion characteristics of the input video.

8. The apparatus of any of the previous embodiments, wherein said circular set of tracking buffers are smaller than said set of full size frame buffers, and said tracking buffers receive downsized frame data.

9. The apparatus of any of the previous embodiments, wherein said stroboscopic output shows spatially displaced objects in a single frame, or spatially displaced objects in each of a sequence of frames, in response to one or more moving objects that are temporally displaced in frames of the video input.

10. The apparatus of any of the previous embodiments, wherein positions of said spatially displaced moving objects depict an actual moving object position as well as a trail of separated previous positions of that object.

11. The apparatus of any of the previous embodiments, wherein said programming executable on said non-transitory computer readable medium is configured for performing an initialization when at least two frames have been received, and for generating said stroboscopic output when at least three frames have been received.

12. The apparatus of any of the previous embodiments, wherein said programming executable on said non-transitory computer readable medium is configured for generating said spatially displaced object positions in a frame, or frames, in said stroboscopic output, in response to steps comprising: assigning a current image frame to a current stroboscopic image; setting a previous frame pointer; adding a motion vector from a previous frame to a motion vector of a stroboscopic frame; aligning a previous stroboscopic mask with a current image; aligning a previous stroboscopic image with the current image; copying aligned previous stroboscopic object areas by utilizing the aligned previous object mask; copying objects in the current frame to a current stroboscopic image by utilizing a current object mask and a background image; checking for stroboscopic object gap by intersecting the current stroboscopic mask and the current object mask; executing the following if a gap exists between the current stroboscopic mask and the current object mask, or an interval counter is equal to an interval upper limit, whereby steps comprising are executed: setting the interval counter to zero; setting a stroboscopic motion vector to zero; copying the current object mask to the current stroboscopic object mask; copying the current stroboscopic image to the previous stroboscopic image; copying the current stroboscopic object mask to the previous stroboscopic object mask; and returning a stroboscopic image.

13. The apparatus of any of the previous embodiments, wherein said programming executable on said non-transitory computer readable medium is configured to perform said stroboscopic output generation in real time.

14. The apparatus of any of the previous embodiments, wherein said apparatus comprises a camera or mobile device configured for capturing the video input.

15. An apparatus for generating stroboscopic output from a video input, comprising: a computer processor configured for receiving and processing a video input; a circular set of tracking buffers configured for object tracking, and comprising at least three tracking buffers for storing a downsized version of at least a previous, current and next frame; a set of full size frame buffers configured for use during full size frame stroboscopic generation; and programming in a non-transitory computer readable medium and executable on the computer processor for performing steps comprising: downsizing frames of said video input and storing in said circular set of tracking buffers; storing full size frames in a set of full size frame buffers; performing object tracking routines to determine object mask and bounding box information about objects moving in frames of the video input; upsizing object mask and bounding box information back to full image size for use with said set of full size frame buffers; performing background extraction in response to upsized object mask and bounding box information in relation to said full size frame buffers, so that a background is generated without moving objects; and generating spatially displaced object positions in a frame, or frames, of stroboscopic output, based on said upsized object mask and bounding box information, with positions of spatially displaced moving objects depicting an actual moving object position as well as a trail of separated previous positions of that object, and repeating stroboscopic output generation for every incoming image frame until a desired frame or frames of stroboscopic output is created.

16. The apparatus of any of the previous embodiments, wherein said programming executable on said non-transitory computer readable medium is configured to perform said object tracking routines based on an image alignment process, followed by generating two absolute difference images for each new frame which are compared in a relative threshold operation to generate rough contours in each of absolute difference images which are intersected followed by determining a bounding box.

17. The apparatus of any of the previous embodiments, wherein said programming executable on said non-transitory computer readable medium is configured for stroboscopic video generation in which spatially displaced object positions are generated in the frame according to an object insertion interval performed in response to a fixed or automatic-interval motion process, that can be user selected.

18. The apparatus of any of the previous embodiments, wherein said programming executable on said non-transitory computer readable medium is configured to perform said stroboscopic output generation in real time.

19. The apparatus of any of the previous embodiments, wherein said apparatus comprises a camera or mobile device configured for capturing the video input.

20. A method for generating stroboscopic output from a video input, comprising: receiving a video input within a processor equipped device configured for executing said method; storing downsized frames from the video input into a circular set of tracking buffers configured for object tracking; storing full sized frames from the video input into a set of full size frame buffers configured for use during full size frame stroboscopic generation; performing object tracking to determine object mask and bounding box information about objects moving in frames of the video input; upsizing object mask and bounding box information back to full image size for use with said set of full size frame buffers; performing background extraction in response to upsized object mask and bounding box information in relation to said full size frame buffers, so that a background is generated without moving objects; and generating spatially displaced object positions in a frame, or frames, of stroboscopic output, based on said upsized object mask and bounding box information.

Although the description above contains many details, these should not be construed as limiting the scope of the technology but as merely providing illustrations of some of the presently preferred embodiments of this technology. Therefore, it will be appreciated that the scope of the present technology fully encompasses other embodiments which may become obvious to those skilled in the art, and that the scope of the present technology is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present technology, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for generating stroboscopic output from a video input, comprising:
(a) a computer processor configured for receiving and processing a video input;
(b) a circular set of tracking buffers configured for object tracking;
(c) a set of full size frame buffers configured for use during full size frame stroboscopic generation; and
(d) programming in a non-transitory computer readable medium and executable on the computer processor for performing steps comprising:
(i) downsizing frames of said video input and storing in said circular set of tracking buffers;
(ii) storing full size frames in a set of full size frame buffers;
(iii) performing object tracking routines to determine object mask and bounding box information about objects moving in frames of the video input;
(iv) upsizing object mask and bounding box information back to full image size for use with said set of full size frame buffers;
(v) performing background extraction in response to upsized object mask and bounding box information in relation to said full size frame buffers, so that a background is generated without moving objects; and
(vi) generating spatially displaced object positions in a frame, or frames, of stroboscopic output, based on said upsized object mask and bounding box information.

2. The apparatus recited in claim 1, wherein said circular set of tracking buffers comprises at least three tracking buffers for storing a downsized version of at least a previous, current and next frame.

3. The apparatus recited in claim 1, wherein said programming executable on said non-transitory computer readable medium is configured to repeat stroboscopic output generation for every incoming image frame until a desired frame or frames of stroboscopic output is created.

4. The apparatus recited in claim 1, wherein said programming executable on said non-transitory computer readable medium is configured to perform object tracking routines with a one-frame delay.

5. The apparatus recited in claim 1, wherein said programming executable on said non-transitory computer readable medium is configured to perform said object tracking routines based on an image alignment process, followed by generating two absolute difference images for each new frame which are compared in a relative threshold operation to generate rough contours in each of absolute difference images which are intersected followed by determining a bounding box.

6. The apparatus recited in claim 1, wherein said programming executable on said non-transitory computer readable medium is configured for generating a stroboscopic video frame, or frames, wherein said spatially displaced object positions are generated in the frame according to an object insertion interval performed in response to a fixed or automatic-interval motion process.

7. The apparatus recited in claim 6, wherein said programming executable on said non-transitory computer readable medium is configured for selecting said object insertion interval in response to user input, or in response to a predetermined value, or in response to selecting it automatically based on motion characteristics of the input video.

8. The apparatus recited in claim 1, wherein said circular set of tracking buffers are smaller than said set of full size frame buffers, and said tracking buffers receive downsized frame data.

9. The apparatus recited in claim 1, wherein said stroboscopic output shows spatially displaced objects in a single frame, or spatially displaced objects in each of a sequence of frames, in response to one or more moving objects that are temporally displaced in frames of the video input.

10. The apparatus recited in claim 9, wherein positions of said spatially displaced moving objects depict an actual moving object position as well as a trail of separated previous positions of that object.

11. The apparatus recited in claim 1, wherein said programming executable on said non-transitory computer readable medium is configured for performing an initialization when at least two frames have been received, and for generating said stroboscopic output when at least three frames have been received.

12. The apparatus recited in claim 1, wherein said programming executable on said non-transitory computer readable medium is configured for generating said spatially displaced object positions in a frame, or frames, in said stroboscopic output, in response to steps comprising:
(a) assigning a current image frame to a current stroboscopic image;
(b) setting a previous frame pointer;
(c) adding a motion vector from a previous frame to a motion vector of a stroboscopic frame;
(d) aligning a previous stroboscopic mask with a current image;
(e) aligning a previous stroboscopic image with the current image;
(f) copying aligned previous stroboscopic object areas by utilizing the aligned previous object mask;
(g) copying objects in the current frame to a current stroboscopic image by utilizing a current object mask and a background image;
(h) checking for stroboscopic object gap by intersecting the current stroboscopic mask and the current object mask;
(i) executing the following if a gap exists between the current stroboscopic mask and the current object mask, or an interval counter is equal to an interval upper limit, whereby steps are executed comprising:
(1) setting the interval counter to zero;
(2) setting a stroboscopic motion vector to zero;
(3) copying the current object mask to the current stroboscopic object mask;
(4) copying the current stroboscopic image to the previous stroboscopic image;
(5) copying the current stroboscopic object mask to the previous stroboscopic object mask; and
(j) returning a stroboscopic image.

13. The apparatus recited in claim 1, wherein said programming executable on said non-transitory computer readable medium is configured to perform said stroboscopic output generation in real time.

14. The apparatus recited in claim 1, wherein said apparatus comprises a camera or mobile device configured for capturing the video input.

15. An apparatus for generating stroboscopic output from a video input, comprising:
(a) a computer processor configured for receiving and processing a video input;
(b) a circular set of tracking buffers configured for object tracking, and comprising at least three tracking buffers for storing a downsized version of at least a previous, current and next frame;
(c) a set of full size frame buffers configured for use during full size frame stroboscopic generation; and
(d) programming in a non-transitory computer readable medium and executable on the computer processor for performing steps comprising:
(i) downsizing frames of said video input and storing in said circular set of tracking buffers;
(ii) storing full size frames in a set of full size frame buffers;
(iii) performing object tracking routines to determine object mask and bounding box information about objects moving in frames of the video input;
(iv) upsizing object mask and bounding box information back to full image size for use with said set of full size frame buffers;
(v) performing background extraction in response to upsized object mask and bounding box information in relation to said full size frame buffers, so that a background is generated without moving objects; and
(vi) generating spatially displaced object positions in a frame, or frames, of stroboscopic output, based on said upsized object mask and bounding box information, with positions of spatially displaced moving objects depicting an actual moving object position as well as a trail of separated previous positions of that object, and repeating stroboscopic output generation for every incoming image frame until a desired frame or frames of stroboscopic output is created.

16. The apparatus recited in claim 15, wherein said programming executable on said non-transitory computer readable medium is configured to perform said object tracking routines based on an image alignment process, followed by generating two absolute difference images for each new frame which are compared in a relative threshold operation to generate rough contours in each of absolute difference images which are intersected followed by determining a bounding box.

17. The apparatus recited in claim 15, wherein said programming executable on said non-transitory computer readable medium is configured for stroboscopic video generation in which spatially displaced object positions are generated in the frame according to an object insertion interval performed in response to a fixed or automatic-interval motion process that can be user selected.

18. The apparatus recited in claim 15, wherein said programming executable on said non-transitory computer readable medium is configured to perform said stroboscopic output generation in real time.

19. The apparatus recited in claim 15, wherein said apparatus comprises a camera or mobile device configured for capturing the video input.

20. A method for generating stroboscopic output from a video input, comprising:
(a) receiving a video input within a processor equipped device configured for executing said method;
(b) storing downsized frames from the video input into a circular set of tracking buffers configured for object tracking;
(c) storing full sized frames from the video input into a set of full size frame buffers configured for use during full size frame stroboscopic generation;
(d) performing object tracking to determine object mask and bounding box information about objects moving in frames of the video input;
(e) upsizing object mask and bounding box information back to full image size for use with said set of full size frame buffers;
(f) performing background extraction in response to upsized object mask and bounding box information in relation to said full size frame buffers, so that a background is generated without moving objects; and
(g) generating spatially displaced object positions in a frame, or frames, of stroboscopic output, based on said upsized object mask and bounding box information.
